(19) United States
(12) Patent Application Publication
(10) Pub. No.: US 2024/0381900 A1
(43) Pub. Date: Nov. 21, 2024

(54) METHOD FOR PREPARING A GEL BLOCK

(71) Applicant: Ynsect, Évry-Courcouronnes Cedex (FR)

(72) Inventors: Thibault SARTON DU JONCHAY, Chevières (FR); Adam KIRECHE, Champigny-Sur-Marne (FR); Anthony LAFFORGUE, Juvisy Sur Orge (FR); Fanny PERYCHOU, Athis-Mons (FR)

(73) Assignee: Ynsect, Évry-Courcouronnes Cedex (FR)

(21) Appl. No.: 18/578,433

(22) PCT Filed: Jul. 8, 2022
(86) PCT No.: PCT/FR2022/051384

§ 371 Date: Jan. 11, 2024

(30) Foreign Application Priority Data
Jul. 13, 2021 (FR) FR2107607

(51) Int. Cl. A23K 20/163; A23K 20/24; A23K 40/00; A23K 50/90; C08J 3/075; C08K 3/26

(52) U.S. Cl. CPC A23K 20/163; A23K 20/24; A23K 40/00; A23K 50/90; C08J 3/075; C08K 3/26; C08J 2305/04; C08K 2003/265; C08K 2201/005

(57) ABSTRACT

The present invention relates to a method for preparing a gel block comprising the following steps:—providing an alginate and calcium carbonate preparation (S1),—providing a buffer solution (S2),—mixing (E4) the alginate and calcium carbonate preparation (S1) with the buffer solution (S2) using a mixing tee comprising an outlet duct, and subsequently,—gelling said mixture in a gelator formed by the outlet duct, and/or a duct connected to the outlet duct, to form a gel block.

The present invention relates to a method for preparing a gel block.

Rearing animals, and in particular insects, requires a more or less substantial water supply according to the animals' nutritional requirements. This water supply must be capable of being controlled in order to be adjusted according to the circumstances.

Generally, the water requirements of insects are of the order of 2 kg of water to produce 1 kg of mature insects (larvae ready to be slaughtered). On an industrial scale, this therefore represents substantial volumes of water that it is necessary to supply and the management of which must be properly ensured.

Indeed, poor water management can generate:
either insufficient growth if the quantity of water is insufficient,
or a greater insect mortality problem essentially due to the increase of the microbiological risk if the quantity of water is excessive

A water supply in gel form makes it possible to remedy these drawbacks.

Application WO2018/122360 describe in particular a gel obtained from liquid co-products from agro-industry as a source of water and/or nutrients or rearing insects.

Application WO2018/122361 relates to a method for producing blocks of an aqueous gel, including in particular a heating step to allow the dissolution of a gelling agent and a cooling step to allow gelling.

However, this type of gel and the preparation method thereof involve a non-negligible gelling time, which impacts efficiency and productivity. Furthermore, the gelling agent must first be heated to be dissolved in a mixture, then the mixture must be cooled to allow the gelling thereof, these heating and cooling steps involving the presence of additional specific devices (such as a cooling circuit).

Therefore, there is a need for a gel preparation method which is quick and simple to implement.

### SUMMARY OF THE INVENTION

The invention relates to a method for preparing a gel block comprising the following steps:
providing an alginate and calcium carbonate preparation,
providing a buffer solution,
mixing the alginate and calcium carbonate preparation with the buffer solution using a mixing tee comprising an outlet duct, and subsequently
gelling in a gelator formed by the outlet duct and/or a duct connected to the outlet duct, to form a gel block.

Advantageously, the calcium carbonate used in the method according to the invention has a particle size less than 40 μm.

Advantageously, the molar ratio of alginate/calcium carbonate used in the method according to the invention is comprised between 0.2 and 1.8.

Advantageously, the pH of the buffer solution used in the method according to the invention is comprised between 3 and 6.

Advantageously, the volume ratio of alginate and calcium carbonate preparation/buffer solution used in the method according to the invention is comprised between 1 and 10.

Advantageously, in the method according to the invention, the alginate and calcium carbonate preparation and the buffer solution are pumped with a view to the mixing thereof using one or more displacement pumps.

Advantageously, in the method according to the invention, the gelator is a straight duct.

Advantageously, in the method according to the invention, the gelator is a cylindrical duct.

Advantageously, the method according to the invention further comprises a dispensing step, wherein a gel block comes out of the gelator and is deposited on a receiving surface.

Advantageously, the method according to the invention further comprises, at the gelator outlet, a cutting step wherein the gel is cut at predefined time intervals or sizes.

Further specificities and advantages of the invention will become apparent in the detailed description hereinafter. In the appended drawings given by way of non-limiting examples:

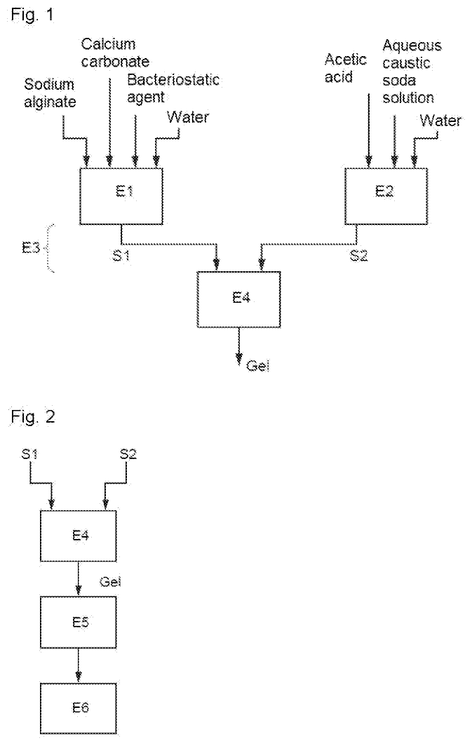

FIG. 1 represents, according to a block diagram, a method for preparing a gel block according to an embodiment of the invention;

FIG. 2 represents, according to a block diagram, the preparation of strips of gel according to an embodiment of the invention; and,

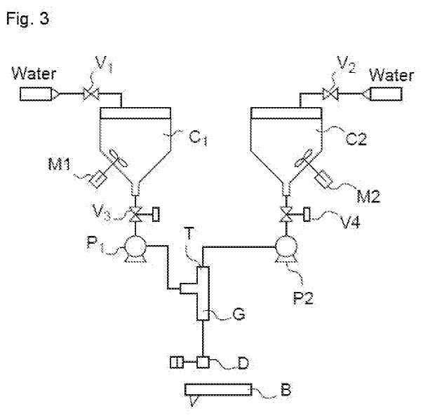

FIG. 3 is a diagram of an industrial installation that can be used in an embodiment of the invention.

### DETAILED DESCRIPTION

The invention relates to a method for preparing a gel block comprising the following steps:
providing an alginate and calcium carbonate preparation,
providing a buffer solution,
mixing the alginate and calcium carbonate preparation with the buffer solution using a mixing tee comprising an outlet duct, and subsequently
gelling in a gelator formed by the outlet duct and/or a duct connected to the outlet duct, to form a gel block.

The term “gel block” refers to a homogeneous mass of gel having advantageously a thickness of at least 2 mm, preferably at least 5 mm.

Preferably, the gel block has a thickness comprised between 7 mm and 45 mm, more preferably, between 10 mm and 35 mm, even more preferably, between 15 mm and 25 mm, such as around 20 mm.

In the present application, unless specified otherwise, all the numerical values given are understood as inclusive of bounds.

The term “around X” refers to the value X plus or minus 10%.

Advantageously, the gel block has a cylindrical shape (or more generally prismatic, and is thus presented in strips).

In particular, the gel block does not have a spherical (or ball) shape.

The term “alginate” refers to the conjugated base of alginic acid, preferably in salt form.

Alginic acid is a polysaccharide formed by residues of D-mannuronic acid (M) and L-guluronic acid (G). It can in particular be characterised by the M/G ratio, which corresponds to the proportion of mannuronic residues with respect to guluronic residues.

Advantageously, the alginate has an M/G ratio comprised between 1.0 and 2.0, preferably, between 1.2 and 1.8, more preferably, between 1.4 and 1.6, even more preferably, equal to 1.4.

Advantageously, the alginate is in monovalent cation salt form, preferably, the alginate is sodium or potassium alginate, more preferably, sodium alginate.

Preferably, the alginate content of the alginate and calcium carbonate preparation is comprised between 0.20% and 0.50%, more preferably, comprised between 0.25% and 0.45%, even more preferably, comprised between 0.30% and 0.40%, for example around 0.38%, the percentages being percentages by weight, with respect to the total weight of the preparation.

Preferably, when the alginate is sodium alginate, the sodium alginate content of the alginate and calcium carbonate preparation is comprised between 0.20% and 0.50%, more preferably, comprised between 0.25% and 0.45%, even more preferably, comprised between 0.30% and 0.40%, for example around 0.38%, the percentages being percentages by weight, with respect to the total weight of the preparation.

The method according to the invention can be carried out according to a discontinuous (“batch”) or continuous mode.

Preferably, the method is carried out in continuous mode.

The method for preparing gel according to the invention is rapid.

In particular, it allows a reduction of the time required for gelling (for example, around a few seconds). It is also very simple to implement. In particular, no heating or cooling step is required.

Furthermore, the gel blocks prepared according to the invention have a low syneresis in order to prevent an excessive release of water and wetting the insects' environment. Syneresis corresponds to the expulsion of liquid from the gel. It is expressed as a percentage by weight of expelled liquid with respect to the initial weight of the gel. Low syneresis is indeed sought to prevent the risks of the insects getting stuck.

Calcium carbonate has the advantage of being compatible for animal feed. Furthermore, the inventors determine that calcium carbonate made it possible to advantageously avoid pre-gelling the alginate and calcium carbonate preparation before mixing with the buffer solution.

Advantageously, the calcium carbonate used in the method according to the invention has a particle size less than 40 μm.

A person skilled in the art knows how to determine a particle size, it can in particular be measured using a granulometer. In particular, when the particle size is less than X μm, this means that all the particles pass through a sieve having meshes of X μm in size.

Preferably, the calcium carbonate has a particle size less than 20 μm, more preferably, less than 15 μm, even more preferably, less than 10 μm.

The use of calcium carbonate of small particle size is particularly preferred when the method according to the invention is a continuous method.

Preferably, the calcium carbonate content of the alginate and calcium carbonate preparation is comprised between 0.10% and 0.40%, more preferably, comprised between 0.15% and 0.35%, even more preferably, comprised between 0.15% and 0.25%, for example around 0.18%, the percentages being percentages by weight, with respect to the total weight of the preparation.

Advantageously, the molar ratio of alginate (alone, without counterion)/calcium carbonate is comprised between 0.2 and 1.8, preferably, comprised between 0.4 and 1.4, more preferably, comprised between 0.5 and 1.3, even more preferably, comprised between 0.6 and 1.2.

To calculate this molar ratio, it is considered that the alginate (alone, without counterion) has a molar mass equal to 176 g/mol (corresponding to a monomer of mannuronate or guluronate).

Advantageously, the alginate used in the method according to the invention is sodium alginate.

Advantageously, the weight ratio of sodium alginate/calcium carbonate is greater than or equal to 1.

Preferably, the weight ratio of sodium alginate/calcium carbonate is comprised between 1 and 5, more preferably between 1 and 3, for example around 2.

Advantageously, the alginate and calcium carbonate preparation further comprises a bacteriostatic agent. A bacteriostatic agent is a substance which stops bacterial proliferation. Preferably, the bacteriostatic agent is propanoic acid.

Preferably, the bacteriostatic agent content of the alginate and calcium carbonate preparation is comprised between 0.05% and 0.40%, more preferably, comprised between 0.10% and 0.35%, even more preferably, comprised between 0.15% and 0.30%, for example around 0.25%, the percentages being percentages by weight, with respect to the total weight of the preparation.

The alginate and calcium carbonate preparation can further comprise a nutritive agent, the nutritive agent being soluble in the preparation.

The term “nutritive agent” refers to an organic or mineral substance used by an organism to live, in particular vitamins and/or minerals.

Advantageously, the alginate and calcium carbonate preparation is obtained by mixing the compounds its constituent (notably, alginate and calcium carbonate, optionally bacteriostatic agent) with water, preferably with tap water. Preferably, the mixing is performed in a tank equipped with a stirrer.

Advantageously, the water content of the alginate and calcium carbonate preparation is greater than 95%, preferably greater than 96%, more preferably, comprised between 97% and 99.5%, even more preferably, comprised between 98% and 99.5%, for example around 99%, the percentages being percentages by weight, with respect to the total weight of the preparation.

The alginate and calcium carbonate preparation is stable, i.e. no start of gelling is observed.

The term “buffer solution” refers to an aqueous solution for maintaining an approximately constant pH when small quantities of acid or base are added, or during a dilution.

Advantageously, the pH of the buffer solution used in the method according to the invention is comprised between 3 and 6.

Preferably, the pH of the buffer solution is comprised between 3.5 and 5.5, more preferably between 4.0 and 5.0, such as for example around 4.8.

Advantageously, the buffer solution can be commercial or prepared on demand. It is usually composed of an acid and a base.

Preferably, the acid is acetic acid and the base is sodium hydroxide. Optionally, a bacteriostatic agent can be added to the buffer solution. Preferably, the buffer solution is of water, acetic acid and sodium hydroxide, constituted optionally with a bacteriostatic agent.

The bacteriostatic agent is preferably propanoic acid.

Advantageously, the bacteriostatic agent content of the buffer solution is comprised between 0.05% and 0.40%, more preferably, comprised between 0.10% and 0.35%, even more preferably, comprised between 0.15% and 0.30%, for example around 0.25%, the percentages being percentages by weight, with respect to the total weight of the buffer solution.

The buffer solution can further comprise a nutritive agent, the nutritive agent being soluble in the buffer solution.

Advantageously, the buffer solution is prepared by mixing the compounds mentioned above (notably acid and base, optionally bacteriostatic agent) with water, preferably with tap water.

Preferably, the mixing is performed in a tank equipped with a stirrer.

The buffer and the alginate and calcium carbonate preparation can be obtained one after the other in any order, or in parallel.

Advantageously, the volume ratio of alginate and calcium carbonate preparation/buffer solution used in the method according to the invention is comprised between 1 and 10.

Preferably, the volume ratio of alginate preparation/buffer solution is comprised between 2 and 8, more preferably between 3 and 6, even more preferably, around 4.

Advantageously, the alginate and calcium carbonate preparation and the buffer solution are drawn off simultaneously from their respective preparation tanks during a draw-off step. They can be drawn off using one or more pumps. For example, the alginate and calcium carbonate preparation can be drawn off using a first pump. The buffer solution can be drawn off using a second pump.

Advantageously, in the method according to the invention, the alginate and calcium carbonate preparation and the buffer solution are pumped with a view to the mixing thereof using one or more displacement pumps.

The displacement pump(s) are preferably rotary pumps, more preferably, eccentric screw pumps or lobe pumps, even more preferably, eccentric screw pumps. The discharge pressure of the pumps can be adjusted according to the gel production scale. For example, for a production of several tens of kilogrammes of gel per hour, their discharge pressure is preferably 2.10⁵ Pa or more.

The alginate and calcium carbonate preparation and the buffer solution drawn off are subsequently mixed so as to obtain a homogeneous mixture. This mixing is carried out in a short time, for example around 0.1 s.

This mixing step is carried out by a mixing tee (sometimes also referred to as “mixing T”). The mixing tee essentially consists of a tube including two inlet ducts and an outlet duct, forming a manifold. The inlet ducts of the mixing tee are respectively used for introducing the alginate and calcium carbonate preparation and the buffer solution into said tee.

A duct can be connected to the outlet duct of the mixing tee.

Advantageously, the outlet duct of the mixing tee is in the same direction as the inlet duct of the buffer solution, and perpendicular to the inlet duct of the alginate and calcium carbonate preparation.

Advantageously, the ducts of the mixing tee have a diameter comprised between 1 and 5 mm. The mixing tee is then referred to as a capillary mixer. The diameter of the capillary (duct) is adapted to the flow rate used; for example, 2 mm for 35 L/h.

Advantageously, in the method according to the invention, the gelator is a straight duct.

The gelling starts from the mixing of the alginate and calcium carbonate preparation with the buffer solution. Advantageously, the gelator does not comprise any element capable of disturbing gel formation, or of breaking the gel formed, such as for example a static mixer.

The gelling is thus carried out continuously, as the alginate and calcium carbonate preparation and the buffer solution are mixed in the mixing tee. This makes it possible to obtain a gel block rapidly.

Thus, the gelling occurs in the outlet duct of the mixing tee and/or in a duct connected to the outlet duct of the mixing tee.

The outlet duct and/or the connected duct thus form a gelator.

Hence, the minimum length of the gelator is adapted to the time required for gelling, such that the transport time in the gelator is at least equal to the time required for gelling.

For example, for a gelling time of approximately 3 s and a gel dispensing speed of 1 m/s, the length of the gelator is at least 3 m.

Advantageously, in the method according to the invention, the gelator is a cylindrical duct.

Advantageously, the gelator is a cylindrical duct having a (constant) diameter of at least 2 mm, preferably 5 mm. This makes it possible to obtain a gel block of cylindrical shape (or strip). Indeed, the gel takes the internal shape of the cylindrical duct, and is therefore presented in the form of a continuous cylinder of the inner diameter of the duct.

Preferably, the cylindrical duct has a diameter comprised between 7 mm and 45 mm, more preferably, between 10 mm and 35 mm, even more preferably, between 15 mm and 25 mm, such as around 20 mm.

Advantageously, the method according to the invention further comprises a dispensing step, wherein a gel block comes out of the gelator and is deposited on a receiving surface.

Advantageously, the receiving surface can be formed of a band of width greater than the thickness of the gel block. For example, when the gelator is a cylindrical duct having a diameter of around 20 mm, the band preferably has a width of around 5 cm.

Furthermore, the outlet of the gelator and the receiving surface are advantageously in motion with respect to each other, it being possible to obtain this relative motion by running the receiving surface under the outlet of the gelator and/or by moving the gelator by translation above the receiving surface. The relative motion between the outlet of the gelator and the receiving surface preferably corresponds to the output speed of the gel, so as not to create excessive stress in the gel by stretching or compression.

Advantageously, the method according to the invention further comprises, at the gelator outlet, a cutting step wherein the gel is cut at predefined time intervals or sizes.

Gel blocks having the desired length are thus formed.

Thus, when a cylindrical duct is used for gelling, gel blocks in the form of strips of desired length are obtained.

In an embodiment, the cutting is carried out by simply stopping the dispensing of the gel. This embodiment is advantageous when the gel block has small dimensions, for example a thickness of less than 45 mm, allowing its cutting solely under the effect of the relative motion between the outlet of the device and the receiving surface.

In another embodiment, an automated cutting system (for example using a blade or a cutting wire) adapted to cut the gel is used.

The cutting system is advantageously located directly at the outlet of the gelator.

FIG. 1 schematically represents a method for preparing a gel according to an embodiment of the invention.

In a step of obtaining an alginate and calcium carbonate preparation E1, the following are mixed in a tank equipped with a stirrer:
alginate such as sodium alginate;
calcium carbonate;
optionally, a bacteriostatic agent; and
water;
   in quantities as defined hereinabove.

The stirrer makes it possible advantageously to prevent settling of the insoluble calcium carbonate.

A stable alginate and calcium carbonate preparation S1 is thus obtained, i.e. no start of gelling is observed.

In a step of obtaining a buffer solution E2, the following are mixed in a second tank equipped with a stirrer:
an acid such as for example acetic acid;
a base, such as an aqueous caustic soda solution; and
water;
   in quantities making it possible to obtain a buffer solution.

A buffer solution S2 prepared directly in the tank is thus obtained.

The tanks used for the alginate and calcium carbonate preparation S1 and the buffer solution S2 can advantageously have a volume adapted to the volume ratio of alginate and calcium carbonate preparation/buffer solution. For example, for a volume ratio of alginate and calcium carbonate preparation/buffer solution equal to 4, the tank for the alginate and calcium carbonate preparation S1 has a volume approximately 4 times greater than that of the tank for the buffer solution S2, such as approximately 400 L for the tank of alginate and calcium carbonate preparation S1 and approximately 100 L for the tank of buffer solution S2.

The step of obtaining an alginate and calcium carbonate preparation E1 and the step of obtaining a buffer solution E2 can be conducted one after the other in any order, or in parallel (notably simultaneously).

In a draw-off step E3, the alginate and calcium carbonate preparation S1 and the buffer solution S2 are drawn off simultaneously from their respective preparation tanks. The alginate and calcium carbonate preparation can be drawn off using a first pump. The buffer solution S2 can be drawn off using a second pump.

The first pump and the second pump are advantageously displacement pumps. Eccentric screw pumps having a discharge pressure of approximately 2.10⁵ Pa have been used successfully.

In a mixing step E4, the alginate and calcium carbonate preparation S1 and the buffer solution S2 drawn off are mixed so as to obtain a homogeneous mixture. This mixing is carried out in a short time, around 0.1 s.

This mixing is carried out in a mixing tee having two inlet ducts and a single outlet duct.

The outlet duct of the mixing tee is advantageously oriented in the same direction as the inlet duct of the buffer solution S2, and perpendicular to the inlet duct of the alginate and calcium carbonate preparation S1.

The gelling starts from the mixing of the alginate and calcium carbonate preparation S1 and the buffer solution S2.

The gelling is thus carried out continuously, as the alginate and calcium carbonate preparation S1 and the buffer solution S2 are mixed in the mixing tee.

The complete gelling typically has a duration of approximately 2 to 5 s. The length of the outlet duct is adapted such that the gelling can occur in the outlet duct of the mixing tee and/or in an optional duct connected to the outlet duct of the mixing tee.

The outlet duct and/or the connected duct thus form a gelator.

The gelling was carried out successfully in a cylindrical tube having a (constant) diameter of 20 mm. For the envisaged applications of the invention, a tube of a diameter between 15 mm and 25 mm may notably be used.

It is obvious that the method for preparing a gel is described hereinabove by way of example and can be adapted without leaving the scope of the present invention.

In particular, an intermediate storage of the alginate and calcium carbonate solution S1 between its preparation tank and its draw-off with a view to the mixing step can be carried out.

Similarly, an intermediate storage of the buffer solution S2 between its preparation tank and its draw-off with a view to the mixing step can be carried out.

Furthermore, the method for obtaining a gel according to the present invention can be carried out with a calcium carbonate solution S1 and/or a buffer solution (S2) that have been previously prepared, such that the step of preparing an alginate and calcium carbonate solution E1 and the step of preparing a buffer solution (E2) are optional.

FIG. 2 schematically represents a method for preparing gel strips capable of being implemented within the scope of the present invention.

An alginate and calcium carbonate preparation S1 and a buffer solution S2 are provided. The alginate and calcium carbonate preparation S1 and a buffer solution S2 are mixed in a mixing step E4.

S1 and S2 can be provided and mixed according to the embodiment example described with reference to FIG. 1.

Following the mixing step, a gel is formed and moves forwards in a duct at the outlet of the tee used for the mixing step E4 (i.e. in the outlet duct of the mixing tee and/or in a duct connected directly thereto). The gelling was carried out successfully in a cylindrical duct having a (constant) diameter of 20 mm. The gel thus takes the internal shape of this duct, and is presented in the form of a continuous cylinder of the inner diameter of the duct.

In a dispensing step E5, the gel block thus formed comes out of the duct wherein it was formed, and is deposited on a receiving surface. The receiving surface can be formed from a band (i.e. a solid, rectilinear and elongated surface), for example a band of a width of around 5 cm. The outlet of the duct and the receiving surface are advantageously in motion in relation to one another.

This relative motion can be obtained by running the receiving surface under the outlet of the duct and/or by moving the duct by translation above the receiving surface. The relative motion between the outlet of the duct and the receiving surface preferably has a speed equal to the output speed of the gel, so as not to create excessive stress in the gel by stretching or compression.

In a cutting step E6, the gel block is cut, at predefined time intervals or sizes. To do this, the cutting is carried out for example by simply stopping the dispensing of the gel block. Its small dimensions allow its cutting solely under the effect of the relative motion between the outlet of the device and the receiving surface. Alternatively, an automated cutting system (for example using a blade or a cutting wire) adapted to cut the gel block is used. The cutting system is located directly at the outlet of the duct wherein the gel is formed.

Gel strips having the desired length are thus formed. These strips are solid enough not to disintegrate under their own weight. Furthermore, the syneresis observed after 1 h at ambient temperature is less than 10%. The syneresis is evaluated by measuring the free water mass after removing the gel strip with a precision scales.

The method according to the invention can be implemented on an industrial scale, for example with an industrial installation as represented in FIG. 3.

The installation represented in FIG. 3 includes two tanks, namely a first tank C1 and a second tank C2. The first tank C1 includes a first mixer M1. The second tank C2 includes a second mixer M2.

The first tank C1 is used to produce the alginate and calcium carbonate preparation S1. The second tank C2 is used to produce the buffer solution S2.

To obtain the alginate and calcium carbonate preparation, the water supply can be carried out in the first tank C1 using a first metering valve V1 located on a water system. The alginate, the calcium carbonate, and optionally the bacteriostatic agent, can be supplied manually into the first tank C1, or using adapted metering devices.

To obtain the buffer solution S2, the water supply can be carried out in the second tank C2 using a second metering valve V2 located on the water system. The acid and the base of the buffer solution, and optionally the bacteriostatic agent, can be supplied manually into the second tank C2, or using adapted metering devices.

The first mixer M1 and the second mixer M2 make it possible respectively to homogenise the alginate and calcium carbonate preparation and the buffer solution S2.

The installation includes a first draw-off valve V3 making it possible to draw off the contents of the first tank C1, namely the alginate and calcium carbonate preparation. The installation also includes a second draw-off valve V4 making it possible to draw off the contents of the second tank C2, namely the buffer solution.

In the installation example represented in FIG. 3, a first pump P1 is used to draw off the contents of the first tank C1 and to pressurise the product located downstream from said first pump P1. A second pump P2 is used to draw off the contents of the second tank C2 and to pressurise the product located downstream from said second pump P2.

The first pump P1 and the second pump P2 are advantageously displacement pumps as defined hereinabove. The use of rotary displacement pumps, for example eccentric screw pumps, is preferred.

The alginate and calcium carbonate preparation S1 and a buffer solution S2 meet in a mixing tee T.

Gelling takes place very quickly after the meeting and mixing of the alginate and calcium carbonate preparation S1 and the buffer solution S2, at the outlet of the mixing tee T in a straight duct forming a gelator G.

At the outlet of the installation, an automated cutting system D can be provided (for example a blade or cutting wire cutting system). The automated cutting system D makes it possible to cut the gel blocks to the desired length, during their dispensing.

The dispensing of the gel blocks is advantageously carried out directly in rearing containers (such as trays or boxes, or other suitable receptacles) which contain animals, namely preferably crawling or essentially crawling insects, or insect larvae.

To do this, the installation represented in FIG. 3 further includes a system for transporting rearing containers, including for example a belt conveyor B. The running of the belt conveyor B is preferably synchronised with the output speed of the gel, so as to avoid creating tensile, compression, or shearing forces, in the gel during its dispensing. Thus, the running speed of the belt conveyor is the same as the output speed of the gel, at least during the dispensing of a gel block into a container transported by the belt conveyor B.

The method according to the invention therefore makes it possible to obtain gel blocks very quickly and simply, and can in particular be implemented on an industrial scale. Furthermore, the implementation of the method is facilitated, because the gelling does not require heating and cooling steps. The industrial installations required to carry out the method proposed in the invention are hence simple and reliable.

Moreover, the method according to the invention allows the formation of a gel produced in situ and dispensed in block form on demand, and continuously. Compared to certain known methods for supplying water in gel form in a farm, handling of the gel and its storage are eliminated, which hence does away with the associated problems, in particular in respect of contamination or rotting. Furthermore, within the scope of rearing animals, for example insects, the size of the blocks at the outlet can be adapted to their requirements, and the blocks can be provided continuously.

Besides rearing insects, the gel produced can be advantageously used for stabilising fruit and vegetable juices, gelling sauce bases, gelling ice-creams and sorbets, adjusting the viscosity of dairy desserts, in protein-enriched gelled bars (for example functional foods, hospital food, etc.), as a replacement of sugar when it is incorporated to texturise a product (for example fruit jam or jelly) in order to preserve this texture by reducing the quantity of sugar or in fillings and/or toppings (pastry pre-product) of grocery products which contain flavoured gels (for example chocolate or fruit flavouring).

The present invention is illustrated, in a non-limiting manner, by the example hereinafter.

### Example 1: Implementation of the Method According to the Invention on a Pilot Scale

### Obtaining an Alginate and Calcium Carbonate Preparation

Sodium alginate having an M/G ratio (proportion of mannuronic residues to glucuronic residues) of 1.4 is used.

The particle size of the calcium carbonate used is less than 10 μm, in particular, 98% of the particles have a size of less than 5.0 μm and 50% have a size of less than 1.5 μm.

The bacteriostatic agent is propanoic acid.

These ingredients are mixed with tap water in the proportions indicated in Table 1 hereinafter. The alginate and calcium carbonate preparation obtained has a neutral pH (comprised between 6.5 and 7.5).

TABLE 1

| Ingredient | Content (%) |
|---|---|
| Alginate (without sodium) | 0.375 |
| CaCO₃ | 0.175 |
| Bacteriostatic agent | 0.25 |
| Water | 99.2 |

Table 1: Composition of the alginate and calcium carbonate preparation, the percentages being percentages by weight, with respect to the total weight of the preparation

The molar ratio of alginate (without counterion)/calcium carbonate in the composition of Table 1 is 1.2.

### Obtaining the Buffer Solution

Acetic acid at an 80% mass concentration and an aqueous caustic soda solution at 50% by weight are mixed with water in the proportions indicated in Table 2 hereinafter.

TABLE 2

| Ingredient | Content (%) |
|---|---|
| 80% acetic acid | 0.85 |
| 50% Aqueous NaOH solution | 0.55 |
| Water | 98.6 |

Table 2: Composition of the buffer solution, the percentages being percentages by weight, with respect to the total weight of the solution

A buffer solution of which the pH is 4.76 is this obtained.

### Obtaining the Gel From the Above Compositions

A gel is obtained by mixing the alginate and calcium carbonate preparation with the buffer solution in a volume ratio of 4:1.

For this, a homogeneous mixture is produced in 0.1 s or less.

The gelling time obtained is approximately 3 s.

### Method for Preparing the Gel

The method for preparing the gel is carried out according to the description hereinabove of the method according to FIGS. 1 and 2.

In a step of obtaining an alginate and calcium carbonate preparation E1 (see FIG. 1), the following are mixed in a 400 L tank equipped with a stirrer:
sodium alginate;
calcium carbonate;
the bacteriostatic agent; and
   water;
   according to Table 1 hereinabove.

A stable alginate and calcium carbonate preparation S1 is thus obtained, i.e. no start of gelling is observed.

In a step of obtaining a buffer solution E2, the following are mixed in a second 100 L tank equipped with a stirrer:
acetic acid;
an aqueous caustic soda solution; and
water;
   according to Table 2 hereinabove.

A buffer solution S2 prepared directly in the tank is thus obtained.

In a draw-off step E3, the alginate and calcium carbonate preparation S1 and the buffer solution S2 are drawn off simultaneously from their respective preparation tanks. The alginate and calcium carbonate preparation S1 is drawn off using a first pump and the buffer solution S2 is drawn off using a second pump, as described hereinabove.

In a mixing step E4, the alginate and calcium carbonate preparation S1 and the buffer solution S2 drawn off are mixed so as to obtain a homogeneous mixture. This mixing is carried out in a short time, around 0.1 s.

This mixing is carried out by the mixing tee described hereinabove.

The gelling starts from the mixing of the alginate and calcium carbonate preparation S1 and the buffer solution S2.

The gelling is thus carried out continuously, as the alginate and calcium carbonate preparation S1 and the buffer solution S2 are mixed in the mixing tee.

As stated above, within the scope of the present example 1, the complete gelling has a duration of approximately 3 s.

Furthermore, the dispensing speed of the gel is 1 m/s and the minimum length of the outlet duct is 3 m. Thus, the gelling occurs in the outlet duct of the mixing tee and/or in a duct connected to the outlet duct of the mixing tee. The outlet duct and/or the connected duct thus form a gelator. The gelling was carried out successfully in a cylindrical tube having a (constant) diameter of 20 mm.

The gel thus takes the internal shape of this duct, and is presented in the form of a continuous cylinder of the inner diameter of the duct.

In a dispensing step E5 (see FIG. 2), the gel comes out of the duct wherein it was formed, and is deposited on a band of a width of around 5 cm as a receiving surface.

In a cutting step E6, the gel is cut, at predefined time intervals or sizes. These strips are solid enough not to disintegrate under their own weight. Furthermore, the syneresis observed after 1 h is less than 10%. The syneresis is evaluated at ambient temperature (approximately 20° C.), by measuring the free water mass after removing the gel strip with a precision scale.

The method hereinabove was carried out successfully for the production of 36 kg/h and 75 kg/h of gel blocks.

Preliminary results suggest that a production of 0.1 kg/s of gel blocks can be envisaged (360 kg/h). Tanks respectively of 1000 L for the alginate and calcium carbonate preparation and 200 L for the buffer solution can for example be used. Other tank volumes can of course be envisaged, according to the desired production volumes. Furthermore, industrial-scale production according to this method can be envisaged by multiplying the outlets of the device, typically by multiplying the mixing tees.

1. Method for preparing a gel block comprising the following steps:
providing an alginate and calcium carbonate preparation,
providing a buffer solution,
mixing the alginate and calcium carbonate preparation with the buffer solution using a mixing tee comprising an outlet duct, and subsequently
gelling in a gelator formed by the outlet duct and/or a duct connected to the outlet duct, to form a gel block.

2. The method according to claim 1, wherein the calcium carbonate has a particle size of less than 40 μm.

3. The method according to claim 1, wherein the molar ratio of alginate/calcium carbonate is 0.2 to 1.8.

4. The method according to claim 1, wherein the pH of the buffer solution is 3 to 6.

5. The method according to claim 1, wherein the volume ratio of alginate and calcium carbonate preparation/buffer solution is 1 to 10.

6. The method according to claim 1, wherein the alginate and calcium carbonate preparation and the buffer solution are pumped with a view to the mixing thereof using one or more displacement pumps.

7. The method according to claim 1, wherein the gelator is a straight duct.

8. The method according to claim 1, wherein the gelator is a cylindrical duct.

9. The method according to claim 1, further comprising a dispensing step, wherein a gel block comes out of the gelator and is deposited on a receiving surface.

10. The method according to claim 1, further comprising, at the gelator outlet, a cutting step wherein the gel is cut at predefined time intervals or sizes.
